(19) United States
(12) Patent Application Publication
(10) Pub. No.: US 2008/0025306 A1
(43) Pub. Date: Jan. 31, 2008

(54) Internet protocol television system, method for providing internet protocol multicast TV signal, TV transferring apparatus, and TV receiving apparatus

(75) Inventor: Koichiro Kamura, Fujisawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/878,258

(22) Filed: Jul. 23, 2007

(30) Foreign Application Priority Data
Jul. 31, 2006 (JP) 2006-208766

(51) Int. Cl. H04L 12/28

(52) U.S. Cl. 370/390

(57) ABSTRACT

According to one embodiment, an Internet protocol TV system includes a TV station which broadcasts an Internet protocol (IP) multicast TV signal to a multicast-compatible network on an IP network, a first receiving apparatus which receives the TV signal via the multicast-compatible network, a second receiving apparatus disposed on a multicast-incompatible network to the TV station, and a transferring apparatus which is connected to the TV station via the multicast-incompatible network, receives the TV signal broadcasted from the TV station, sets a connection with the second receiving apparatus, and transfers the TV signal to the second receiving apparatus via the connection, wherein the second receiving apparatus and the transferring apparatus each includes a communicator which communicates control information needed to transfer the TV signal on the connection, and a controller which executes transfer control of the TV signal based on the control information communicated by the communicator.

### CROSS-REFERENCE TO RELATED APPLICATIONS

This application is based upon and claims the benefit of priority from Japanese Patent Application No. 2006-208766, filed Jul. 31, 2006, the entire contents of which are incorporated herein by reference.

### BACKGROUND

1. Field

One embodiment of the present invention relates to an Internet protocol (IP) television(TV) system which broadcasts an IP multicast TV signal from a TV station to a TV receiving apparatus via a network compatible with multicast on an IP network, a method for proving an IP multicast TV signal, a TV transferring apparatus, and a TV receiving apparatus.

2. Description of the Related Art

In recent years, an IP TV system which transmits TV contents to a user of a TV receiving apparatus via an IP network other than TV contents through a TV wave from a TV station to the TV receiving apparatus has become widespread.

In the IP TV system, an IP TV system for mobile aimed at a mobile terminal, such as a cellular phone set, has been proposed. When receiving a participation expressing packet including a view-desired multicast address from the mobile terminal at a home agent, this IP TV system for mobile maintains a correspondence of a c/o address of the mobile terminal to the multicast address, and when receiving a multicast packet from a multicast router, the IP TV system makes a copy of the multicast packet onto the c/o address on the mobile terminal corresponding to the multicast address, and encapsulate it in an IP packet to transfer it (e.g., JP-A 2004-260317).

In the meantime, the aforementioned IP TV system provides original TV programs for each provider, and to view the relevant TV programs, the user of the TV system needs to make an agreement with each provider. The user has been strongly desired a TV system which allows the user to selectively view a favorite program out of a plurality of TV programs provided from each provider.

Even the user who has made an agreement with the provider, the place at which a TV receiver is used does not allow the user to view any TV programs sometimes. This is because a router which does not support an IP multicast protocol exists on a path on the way from the TV station to the TV receiver. Therefore, the IP multicast TV is blocked on the way and it cannot be received by the TV receiver.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration view illustrating the first embodiment of an IP TV system concerned in the invention;

FIG. 2 is an exemplary block diagram illustrating a main component configuration of a terminal depicted in FIG. 1;

FIG. 3 is an exemplary view illustrating a configuration of a protocol (protocol stack) each necessary for an IP multicast TV, an IP multicast-compatible router, an IP multicast transferring apparatus, and a subscriber's terminal in the first embodiment;

FIG. 4 is an exemplary sequence view illustrating an example of operations of the IP TV system concerned in the first embodiment;

FIG. 5 is an exemplary flowchart illustrating a control processing procedure of the terminal in the first embodiment;

FIG. 6 is an exemplary view illustrating a configuration of a protocol (protocol stack) each necessary for an IP multicast TV, an IP multicast-compatible router, an IP multicast transferring apparatus, and a subscriber's terminal in the second embodiment of the invention; and

FIG. 7 is an exemplary sequence view illustrating an example of operations of an IP TV system concerned in the second embodiment.

### DETAILED DESCRIPTION

Various embodiments according to the invention will be described hereinafter with reference to the accompanying drawings, In general, according to one embodiment of the invention, an Internet protocol TV system, comprising: a TV station which broadcasts an Internet protocol (IP) multicast TV signal to a multicast-compatible network on an IP network; a first receiving apparatus which receives the TV signal via the multicast-compatible network; a second receiving apparatus disposed on a multicast-incompatible network to the TV station; and a transferring apparatus which is connected to the TV station via the multicast-incompatible network, receives the TV signal broadcasted from the TV station, sets a connection with the second receiving apparatus, and transfers the TV signal to the second receiving apparatus via the connection, wherein the second receiving apparatus and the transferring apparatus each comprise: a communicator which communicates control information needed to transfer the TV signal on the connection; and a controller which executes transfer control of the TV signal based on the control information communicated by the communicator.

### FIRST EMBODIMENT

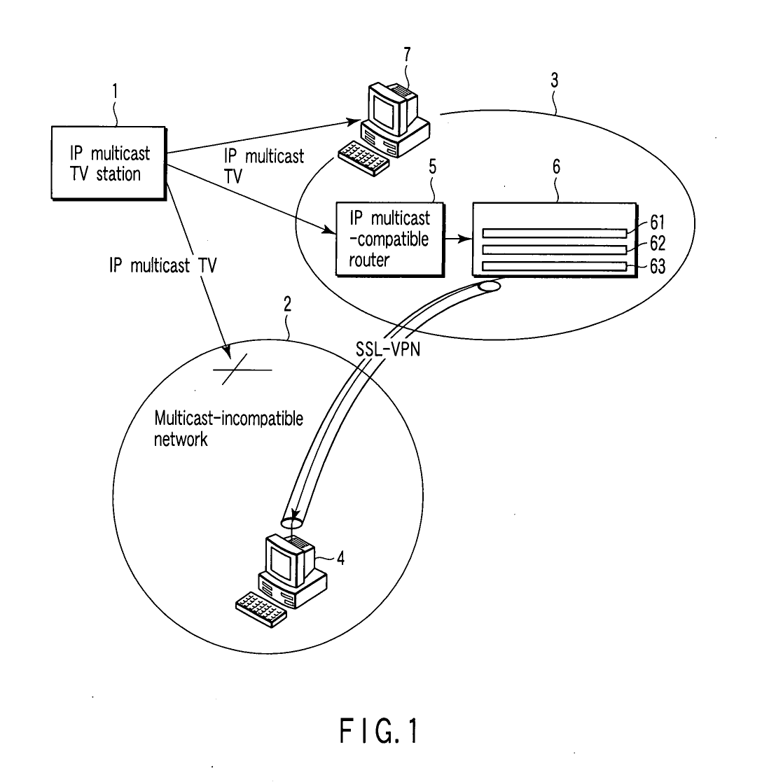

FIG. 1 is a schematic configuration view depicting the first embodiment of an IP TV system concerning the invention. The system comprises an IP multicast TV station (hereinafter, referred to as TV station) 1; a multicast incompatible network (hereinafter, referred to as network) 2; an IP multicast-compatible network (hereinafter, referred to as network) 3, a terminal 4 to be used by a subscriber of a present service; IP multicast-compatible router (hereinafter, referred to router) 5, an IP multicast transferring apparatus (hereinafter, referred to as a transferring apparatus) 6, and a terminal 7 disposed on the network 3.

Here, the terminal 4 to be used by the subscriber of the present service is disposed in the network 2. That is, there exists a router which does not support an IP multicast protocol on a path on the way from the TV station 1 to the terminal 4. Therefore, an IP multicast TV signal (herein after, referred to as TV signal) is blocked on the way the terminal 4 cannot receive it.

The embodiment then disposes the router 5 and the transferring apparatus 6 on the network 3. The router 5 receives the TV signal broadcasted from the TV station 1.

The transferring apparatus 6 establishes a secure socket layer-virtual private network (SSL-VPN) between the apparatus 6 and the terminal 4 disposed in the network 2. The transferring apparatus 6 includes a control information communicator 61 (hereinafter, referred to as communicator 61), an IP multicast TV transfer controller 62 (hereinafter, referred to as controller 62), and a format converter 63.

The communicator 61 communicates control information necessary for transferring the TV signal on the SSL-VPN. The control information is encrypted with an SSL. The control information to be communicated includes a subscriber identification number, a password, a program list, and program selection information.

The controller 62 controls transfer of the TV signal to the terminal 4 based on a communication result from the communicator 61.

The format converter 63 converts the received TV signal into a format enabling displaying it through a Web browser owned by the terminal 4.

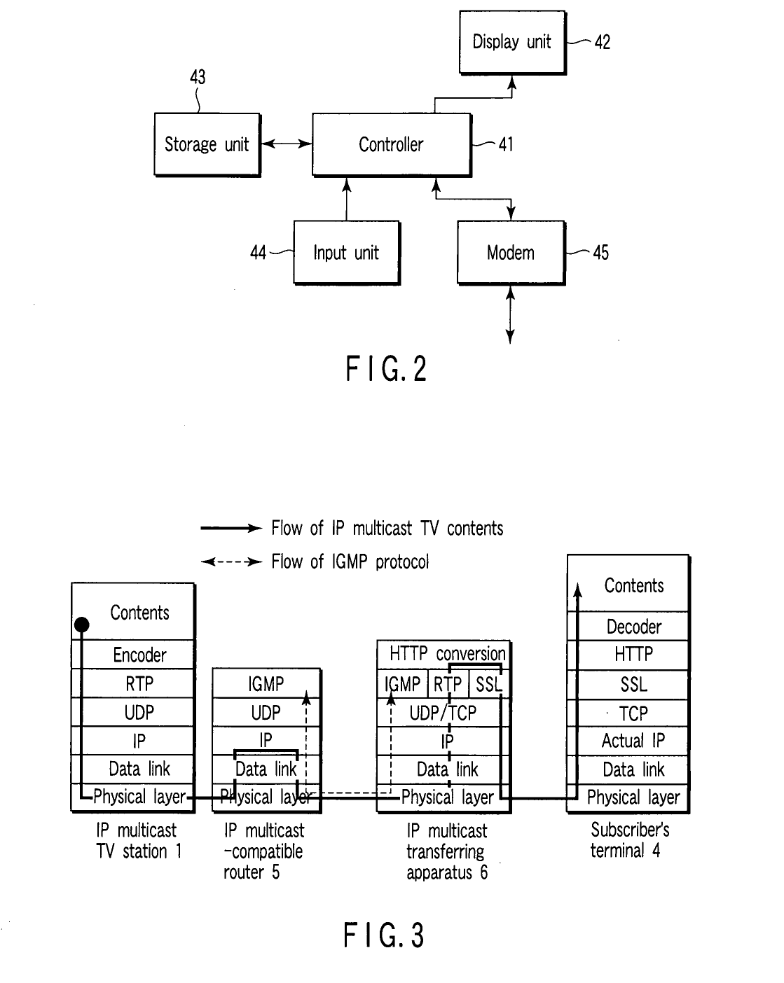

FIG. 2 depicts a block diagram showing a main component configuration of the terminal 4.

The terminal 4 is a personal computer with a TV receiving function and has a controller 41 and a display unit 42 using a CRT.

The controller 41 supplies a video signal included in the TV signal to the display unit 42 to display it and amplifies to output a sound signal from a loud-speaker (not shown).

By the way, the terminal 4, in addition to a TV receiving function, has a request transmitting function of TV contents; and a reproducing function of the TV signal obtained via the SSL-VPN. These functions are achieved by the controller 41, a storage unit 43, an input unit 44 with a keyboard or a mouse, and a modem 45.

Among of them, the input unit 44 is used in order to input a variety of operation instructions to the terminal 4, and also used to input a transmission instruction of an acquisition request for an IP multicast TV program (hereinafter, referred to as TV program) to the transferring apparatus 6.

When the acquisition request for arbitrary TV program is input from the input unit 44, the controller 41 transmits the acquisition request of the TV program to the transferring apparatus 6 from the modem 45 via the SSL-VPN. The controller 41 then receives the TV signal transmitted from the transferring apparatus 6 in response to the acquisition request through the modem 45. To reproduce the TV program passing through the SSL-VPN, an exclusive application tool is set to the controller 41.

FIG. 3 depicts a protocol configuration (protocol stack) each necessary for the TV station 1, router 5, transferring apparatus 6 and terminal 4.

As shown in FIG. 3, the TV station 1 is provided with contents such as a videos and sound; an encoder to encode the video and sound into a form, such as, a moving picture experts group (MPEG); a real-time transport protocol (RTP) to transmit the encoded video and sound; a user data protocol (UDP), an IP; a data link layer, such as, IEEE802.3; and a physical layer of one giga Ethernet (registered trade mark) and 100 Base-T, etc.

The router 5 has an Internet group management protocol (IGMP) in addition to a usual router function.

The transferring apparatus 6 has a physical layer of a one giga Ethernet, a 100 base-T, etc., and a data link layer of the IEEE802.3, etc., has an IP for a network layer, a transmission control protocol (TCP), and a user data protocol (UDP) for a transport layer, and has an Internet group management protocol (IGMP) to make a group participation/secession request for IP multicast for the router 5.

The transferring apparatus 6 has a real-time transport protocol (RTP) to receive a stream of a video and a sound transmitted from the TV station 1, and also has a function of hyper text markup language (HTML) conversion function to convert the stream of the video and sound received through the RTP into an HTML format enabling the terminal 4 of the subscriber to view by means of a Web browser, and an SSL to encrypt the converted HTLM or HTTP message.

The terminal 4 has a physical layer, such as a one G Ethernet and a 100 base-T, a data link layer of the IEEE802.3, etc., has an IP in a network layer, a TCP in a transport layer, an SSL in a session layer, and an HTTP and a Web browser in an application layer.

Next to this, a method for providing an IP multicast TV signal in the system configured as mentioned above will be described.

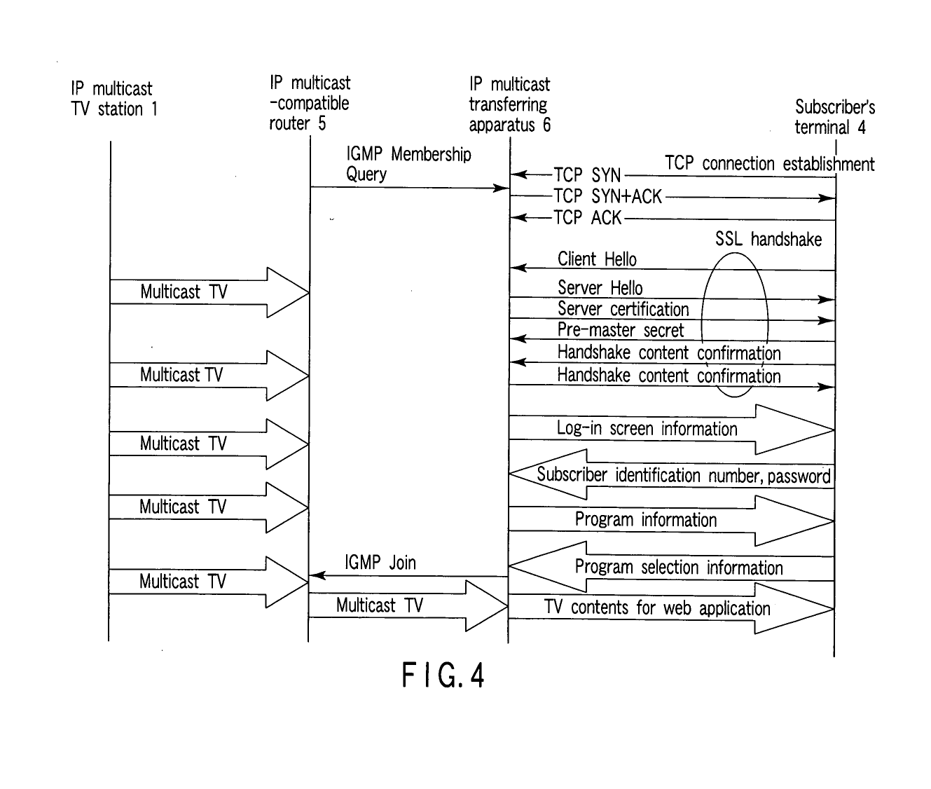

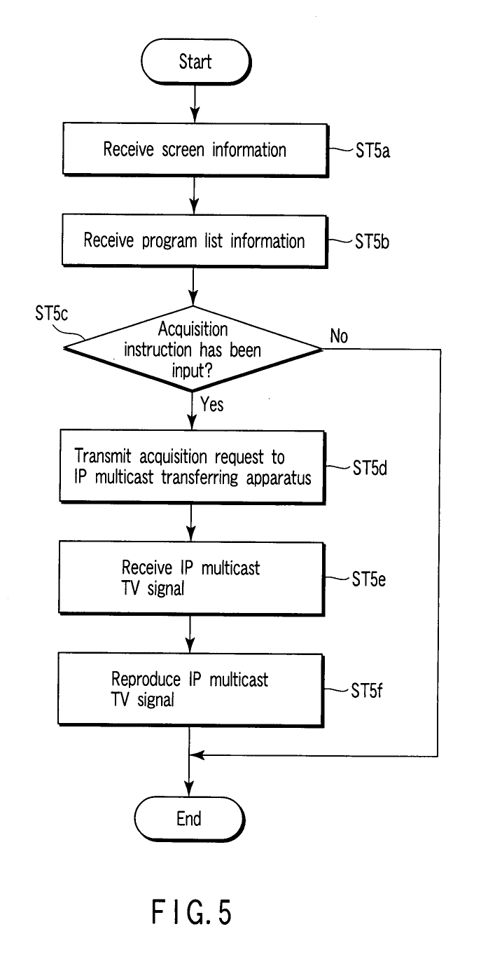

FIG. 4 shows a sequence view depicting an operation example of the IP TV system concerned in the first embodiment of the invention.

A viewer (user) desiring the view of arbitrary TV program provided via the SSL-VPN makes an agreement with a broadcasting company owing the transferring apparatus 6. At that time, the company registers attribute information, such as a name and an address of the user, a telephone number and a mail address of a contact destination, a subscriber identification number, and a password into a customer database of the transferring apparatus 6. The company sends an application tool to the user together with them as well.

The user sets the application tool sent from the company to the terminal 4. As for a transmission method of the application tool, a method of transmitting it as a file attached to an e-mail via the Internet, or a method via mail is available.

The terminal 4 of the subscriber firstly establishes a TCP connection with the transferring apparatus 6. After this, the terminal 4 carries out a handshake protocol of the SSL on the TCP connection to exchange a common key for server authentication and encryption to and from the transferring apparatus 6. After completing the execution of the handshake protocol, the communication through the HTTP after the completion between the terminal 4 and the transferring apparatus 6 is encrypted with the common key.

After that, the transferring apparatus 6 SSL-encrypts log-in screen information described in the HTML to transmit it to the terminal 4.

The terminal 4 then carries out the control processing procedure shown in FIG. 5.

The terminal 4 displays the log-in screen information onto a display unit 42 to prompt the user to input the subscriber identification number and the password.

In such a state, when the user inputs the identification number and the password from the input unit 44, the terminal 4 encrypts the information to transmit it to the transferring apparatus 6.

The transferring apparatus 6 authenticates the user by the use of the identification number and the password. After this, if the authentication of the user completed successfully, it results in the establishment of the SSL-VPN.

The transferring apparatus 6 then transmits the program information consisting of a program list, being described in the HTML and being in broadcasting.

The terminal 4 then shifts from a block ST5a to a block ST5b, and there, it displays the program list being in broadcasting on the Web browser of the display unit 42.

In this status, when the user selects to instruct the program selection information of the IP multicast TV the view of which is desired by the user by means of the input unit 44, the terminal 4 shifts from a block ST5c to a block ST5d, and there, transmits an acquisition request in which the program selection information is encrypted with SSL to the transferring apparatus 6 via the SSL-VPN.

The transferring apparatus 6 then generates a Join message of the IGMP based on the program selection information transmitted from the terminal 4, and transmits it to the router 5. When receiving the IGMP Join message, the router 5 starts transferring the TV signal received from the TV station 1 to the transferring apparatus 6.

After this, the TV signal transferred from the router 5 is received at the transferring apparatus 6 once, and after stream data is extracted from an RTP layer, it is converted into a format to display it through the Web browser of the subscriber, encrypted with SSL then transmitted to the terminal 4 as a packet of TCP/IP.

The terminal 4 receives the packet of TCP/IP transmitted from the transferring apparatus 6 (block ST5e), decrypts it with SSL, then, extracts HTML data, and displays it on the display unit 42 through a Web browser (block ST5f).

Thus, even the terminal 4 disposed on the network 2 becomes possible to receive the TV signal.

As given above, in the first embodiment, the IP TV system receives, by means of the router 5, the TV signal broadcasted from the TV station 1 to transfer it to the transferring apparatus 6, communicates control information needed to transfer the TV signal on the SSL-VPN between the transferring apparatus 6 and the terminal 4 disposed on the network 2, and transfers the TV signal from the transferring apparatus 6 to the terminal 4 based on a communication result of the control information.

Accordingly, the system transferring the TV signal from the TV station 1 to the terminal 4 via the router 5 and the transferring apparatus 6, it becomes possible to receive the TV signal at any place in a company, a school, etc., thereby, the system can extremely improve user's convenience. The system being possible to view a favorite program out of a large number of IP multicast TV programs receivable by the router 5 and the transferring apparatus 6, the system can enhance an amusement property for the user and also implement subscription promotion of a service customer.

In the first embodiment, since the system encrypts to transfer the program selection information and the TV signal with SSL, even if the terminal 4 is disposed in the company or school, the system may improve its security without changing the setting of a fire wall.

In the first embodiment, the system receives the TV signal so far as the terminal 4 may display it through the general-purpose Web browser to display it on the display unit 42. Therefore, using any type of a terminal allows the user to view the TV program.

Further, in the first embodiment, the system has an execution function of the IGMP, etc., in the transferring apparatus 6. Thereby, the system may decrease processing ability of a processor of the terminal 4 by the normecessity of the implementation of the IGMP therein, thereby, the system can achieve reductions of terminal 4 in a size and a const.

### SECOND EMBODIMENT

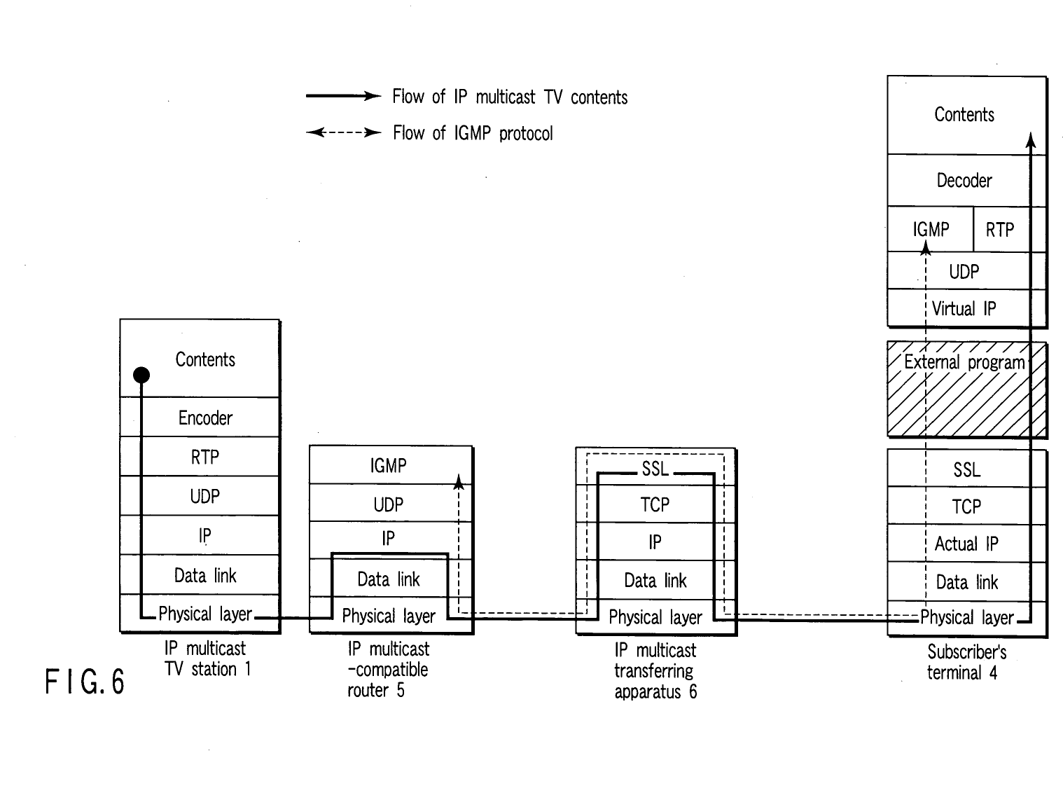

FIG. 6 shows a configuration of protocol (protocol stack) each necessary for a TV station 1, a router 5, a transferring apparatus 6, a subscriber's terminal 4. Differing from FIG. 3, the transferring apparatus 6 does not need to has conversion functions of an Internet group management protocol (IGMP), a real-time transport protocol (RTP) and a (hyper text transport protocol) HTMP. In place of the functions, the system is featured in that the terminal 4 has a user data protocol (UDP), an IGMP, and RTP.

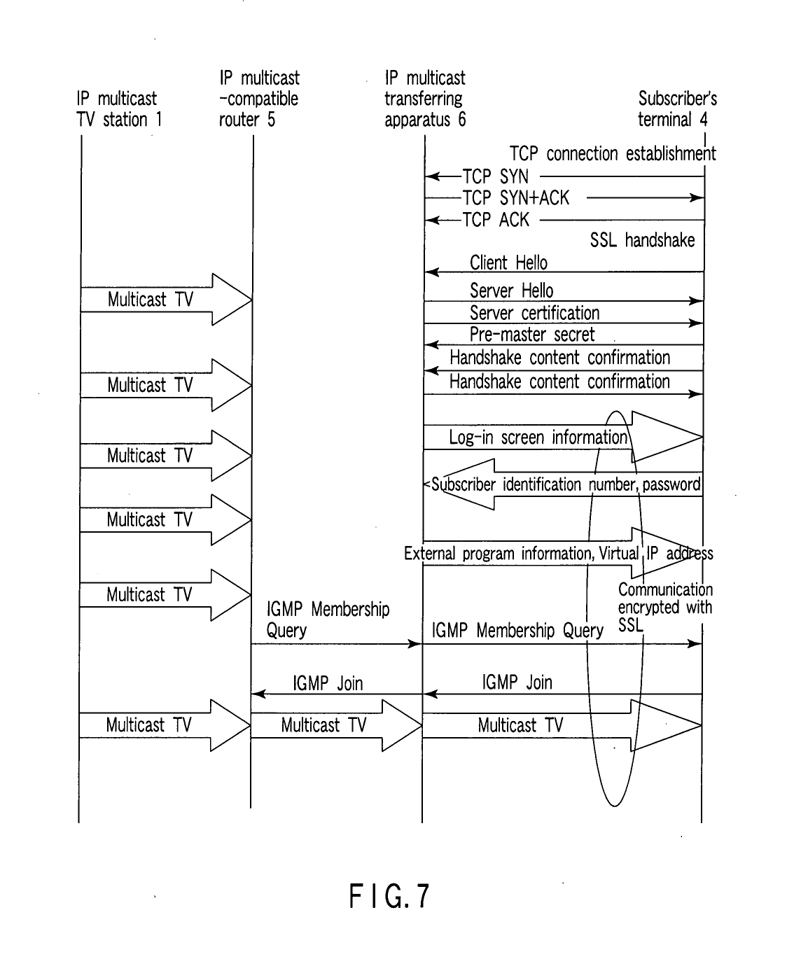

FIG. 7 depicts a sequence view of an operation example of the IP TV system regarding the second embodiment of the invention. The system in the second embodiment differs from that of in FIG. 4 in that the transferring apparatus 6 does not execute the protocol of the IGMP on behalf of the terminal 4, but that the transferring apparatus 6 relays data (contents) of the message of the protocol of the IGMP and of the IP multicast TV which are communicated between the subscriber's terminal 4 and the router 5.

At first, the terminal 4 establishes a TCP connection to and from the transferring apparatus 6. After this, the terminal 4 runs handshake protocol of a secure socket layer (SSL) on the TCP connection to exchange a common key for server authentication and encryption to and from the transferring apparatus 6.

When completing the exchange of the common key for the server authentication and the encryption, the communication, after the expression, between the terminal 4 and the transferring apparatus 6 goes with encryption thereof by the use of the common key.

The transferring apparatus 6 then sends log-in screen information for an IP multicast transfer service to the subscriber's terminal 4. The log-in screen information is information prompting inputs of a subscriber identification number and of a password to a subscriber. In succession, after the user inputs the identification number and the password, the information is encrypted, and the terminal 4 transmits the encrypted information to the transferring apparatus 6.

The transferring apparatus 6 then authenticates the user by using the identification number and the password, and the completion of the authentication of the user results in establishment of a communication path of so-called SSL-VPN.

After successfully completing the authentication of the user, the transferring apparatus 6 transmits an external program to the terminal 4, and assigns a virtual IP address to the terminal 4 as well. The virtual IP address is used for an address of the terminal 4 of an IP packet to be encapsulated for encapsulating data on the communication path on the SSL-VPN. The external protocol is a program to transfer a packet, sending an IGMP Join message, etc., which is generated in running an application to receive the TV signal at the terminal 4 to the router 5, into an SSL layer. The external program is a program created in a language, such as Java (registered trade mark) and Active X.

After that, the message of the protocol of the IGMP, such as an IGMP Join message which has been transferred to the SSL layer, is sent to the transferring apparatus 6 via the communication path on the SSL-VPN. The transferring apparatus 6 relays the message to the router 5.

The transferring apparatus 6 relays the data of the IP multicast TV received from the router 5 to the terminal 4 through the SSL-VPN.

Thus, even the terminal 4 disposed on the network 2 becomes possible to receive the TV signal.

As mentioned above, in the second embodiment, the IP TV system can obtain operation effect similar to that of the first embodiment, and also is provided an execution function, such as an IGMP, for the terminal 4. Therefore, the transferring apparatus 6 may decrease in processing load by the normecessity of execution of the IGMP, thereby; inexpensive transferring apparatus may be placed on the network 3, and the whole of the system may be achieved with a cost.

### OTHER EMBODIMENT

The invention is not limited to the forgoing each embodiment. For example, each of the embodiments has described an example to connect an IP multicast transfer device with a terminal disposed in a multicast-incompatible network through an SSL-VPN. However, the invention is not limited to such an example; the invention may use a connection enabling an IP multicast TV signal to safely transfer without changing, for example, a fire wall.

Other than this, a configuration of a system, a configuration of a terminal, a function of an IP multicast transfer function, a method for providing an IP multicast TV signal, etc., may be made in various modifications without departing from the sprit or scope of the inventive concept of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An Internet protocol TV system, comprising:
a TV station which broadcasts an Internet protocol (IP) multicast TV signal to a multicast-compatible network on an IP network;
a first receiving apparatus which receives the TV signal via the multicast-compatible network;
a second receiving apparatus disposed on a multicast-incompatible network to the TV station; and
a transferring apparatus which is connected to the TV station via the multicast-incompatible network, receives the TV signal broadcasted from the TV station, sets a connection with the second receiving apparatus, and transfers the TV signal to the second receiving apparatus via the connection, wherein
the second receiving apparatus and the transferring apparatus each comprise:
a communicator which communicates control information needed to transfer the TV signal on the connection; and
a controller which executes transfer control of the TV signal based on the control information communicated by the communicator.

2. The Internet protocol TV system, according to claim 1, wherein
the transferring apparatus establishes a secure socket layer protocol-virtual private network to and from the second receiving apparatus; and
the communicator encrypts to communicate the control information by use of common encryption key information defined by an secure socket layer between the transferring apparatus and the second receiving apparatus.

3. The Internet protocol TV system according to claim 1, wherein the transferring apparatus further comprises:
a converter which converts the received TV signal into a format possible to display the received TV signal by a general-purpose browser of the second receiving apparatus.

4. The Internet protocol TV system according to claim 1, wherein
the transferring apparatus includes a router which receives the TV signal from the TV station, and a transfer unit to transfer the TV signal to the second receiving apparatus,
the transfer unit transmits a Join message defined by an Internet group management protocol when a receiving request for the TV signal is made from the second receiving apparatus, and
the router transfers the TV signal to the transfer unit, when the Join message is received.

5. The Internet protocol TV system according to claim 1, wherein
the transferring apparatus includes a router which receives the TV signal from the TV station, and a transfer unit which transfers the TV signal to the second receiving apparatus,
the second receiving apparatus transmits a Join message defined by an Internet group management protocol to the router via the transfer unit, when receiving the TV signal, and
the router transfers the TV signal transmitted from the TV station, to the second receiving apparatus via the transfer unit, when the Join message is received.

6. A method for providing an Internet protocol multicast TV signal for use in an Internet protocol TV system, including a TV station, a first receiving apparatus to be connected to the TV station via a multicast-compatible network, a second receiving apparatus disposed on a multicast-incompatible network to the TV station, and a transferring apparatus to be connected to the TV station via the multicast-compatible network, comprising:
broadcasting the TV signal from the TV station to the first receiving apparatus and the transferring apparatus via the multicast-compatible network;
setting a connection with the second receiving apparatus and the transferring apparatus, to transfer the TV signal to the second receiving apparatus;
communicating control information needed to transfer the TV signal on the connection between the second receiving apparatus and the transferring apparatus; and
executing transferring the TV signal to the second receiving apparatus by the transferring apparatus, based on the communicated control information.

7. A TV transferring apparatus which is connected to a TV station via a multicast-compatible network on an Internet protocol network, comprising:
a receiver which receives an Internet protocol multicast TV signal broadcasted from the TV station;
a set unit to set a connection with a receiving apparatus on a multicast-incompatible network, to transfer the TV signal to the receiving apparatus;
a communicator which communicates control information needed to transfer the TV signal on the connection to and from the receiving apparatus; and
a controller which executes transfer control of the TV signal to the receiving apparatus, based on the control information which is communicated by the communicator.

8. A TV receiving apparatus disposed on a multicast-incompatible network on an Internet protocol network to a TV station, comprising:
a set unit to set a connection with a transferring apparatus on a multicast-compatible network, to receive an Internet protocol multicast TV signal from the TV station;
a communicator which communicates control information needed to transfer the TV signal on the connection to and from the transferring apparatus; and
a receiver which receives the TV signal transferred from the transferring apparatus, base on the control information which is communicated by the communicator.
